(19) United States
(12) Patent Application Publication
(10) Pub. No.: US 2014/0254391 A1
(43) Pub. Date: Sep. 11, 2014

(54) ESTIMATION OF SMALL CELL DENSITY

(71) Applicant: RADISYS CORPORATION, Hillsboro, OR (US)

(72) Inventors: Nagi Jayaraman Mahalingam, San Diego, CA (US); Guruprasad Mukunda Rao, Bangalore (IN); Suhas Gururaj Rao, Udupi District (IN)

(73) Assignee: RADISYS CORPORATION, Hillsboro, OR (US)

(21) Appl. No.: 13/786,066

(22) Filed: Mar. 5, 2013

(51) Int. Cl. H04W 52/14

(52) U.S. Cl. CPC H04W 52/146
USPC 370/241.1

(57) ABSTRACT

The embodiments herein relate to communication networks and, more particularly, to small cells in wireless communication networks. The embodiments herein disclose a mechanism for determining an upper limit for the uplink transmission power for a small base station in the small cell, based on small cell density and co-channel interference.

### TECHNICAL FIELD

The embodiments herein relate to communication networks and, more particularly, to small cells in wireless communication networks.

### BACKGROUND

The cellular telecommunications network employs various cellular components to extend the physical range of the base station. One such cellular component employed is the small cell. The small cell acts an access point to the base station and provides scalable, multi-channel, two-way communications with the base station with which it is associated. The principal functions of the small cell are for coverage extension and for offloading users from the cellular network. The small cell reduces network infrastructure cost, reduces traffic on the traditional radio network, and provides subscribers with better indoor coverage.

However, the area of operation of the small cell is very small, as compared to other forms of cellular communications, such as the macrocells and the like. As a result, when a number of mobile communication devices devices (also referred to herein as mobile devices or simply as mobiles) are operating under a particular small cell, there is a possibility of interference during the communication of the mobile devices. To mitigate the interference, the base stations in small cells may vary their transmitting power, based on the interference detected and other metrics at each small cell. The small cells have a non-constant downlink transmit power and the power is set such that both capacity and coverage are maximized. Setting the transmit power to maximize capacity may indicate a transmission power threshold exceeding what is considered optimal and instead contribute to an increase in interference for neighboring small cells and macro cells.

Currently, there are schemes which suggest placing a cap on the transmitting power of small cells and/or a cap on the transmission power of mobile devices served by small cells, based on the density of small cells in a specific area. However, due to the ad-hoc deployment of small cells, the density of small cells in a specific area varies and cannot be pre-determined (due to factors such as macro cell breathing and so on). The densities of the small cells and the interference a small cell can cause to the macro layer have to be computed by the network operator and fed into the system. While this method is sufficient currently, this is not a scalable option for the operator as the small cell density grows. This is not a proactive method of operation, as the interference may vary over time (due to environmental conditions, geography and so on).

### BRIEF DESCRIPTION OF THE DRAWINGS

The embodiments herein will be better understood from the following detailed description with reference to the drawings, in which:

FIG. 1 illustrates the architecture of a cellular network, according to an embodiment as disclosed herein;

FIG. 2 depicts an operation administration maintenance (OAM) system, according to an embodiment as disclosed herein;

FIG. 3 is a sequence diagram depicting a process of determining an upper limit for the uplink transmission power for a mobile station in the small cell, according to an embodiment as disclosed herein; and

FIG. 4 is a flow chart depicting a process of determining an upper limit for uplink transmission power for a mobile station in the small cell, according to an embodiment as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

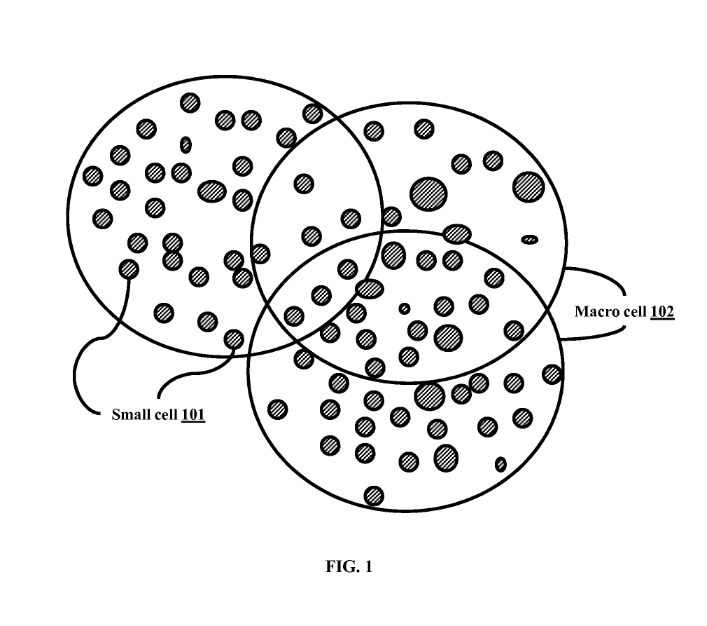

The embodiments herein disclose a mechanism for determining a power cap for a small cell based on small cell density and co-channel interference. Referring now to the drawings, and more particularly to FIGS. 1 through 4, where similar reference characters denote corresponding features consistently throughout the figures, there are shown embodiments.

FIG. 1 illustrates the architecture of a cellular network, according to an embodiment as disclosed herein. The cellular network comprises a plurality of macro cells 102 and a plurality of small cells 101. The small cells 101 are cells which cover a smaller area; and use low powered radio access nodes (wherein the radio access nodes used in small cells 101 are low powered as compared to radio access nodes used in macro cells 102). The small cells 101 may be femtocells, microcells, picocells, metrocells and so on. The macro cells 102 are larger cells that cover a large area. The coverage area of each macro cell 102 comprises and in many instances, overlaps of a plurality of small cells 101.

The small cells 101 and the macro cells 102 are connected to the cellular network and an operations and maintenance (OAM) network using suitable means. An OAM network or system may also be referred to herein as a home enhanced node B (HeNB) management system, or HeMS. The suitable means may be using a wired means, a wireless means, an Internet Protocol (IP) network based means and so on.

The OAM system in the network receives information from the small cells 101 connected to the cellular network in a continuous manner. The information comprises information such as the location of the cells, for example Global Positioning System (GPS) coordinates of neighboring macro cells and small cells, radio frequency (RF) footprints of macro cells and small cells and cell identities of neighboring macro and small cells. Cell Identities here refers to an embodiment that uniquely identifies the radio node in the network. For example, this could be the 28 bit Cell Identity as broadcast in System Information Block#3 in a wideband code division multiple access (WCDMA) radio node. RF footprints refer to the received power level of a neighbor from the small cell perspective. Specifically, the strongest macro cell detected by a given small cell is used to ascertain the location of the given small cell with an accuracy corresponding to the size of that macro cell. The RF footprints are obtained by means of a network listening function where the small cells receive on their downlink ephemeral and broadcast channel data from nearby macro cells in addition to power readings of those neighboring cells. The network listening function may also be referred to as Radio Environment Monitoring (REM). In addition to REM scans, the small cell can also employ Automatic Neighbor Relation (ANR) functions using mobile devices attached to the small cell. A suitable protocol such as TR-069 and a suitable data model such as TR-196 may be used for communicating information between the OAM system and the small cell. The information may be received at periodic pre-defined or autonomously decided intervals. The information may be also sent by the small cells to the OAM network on a specific event occurring (such as the small cell starting up and so on). In another embodiment herein, the OAM network may detect the location of the cells using an available suitable method (such as report of Global Positioning System (GPS) data from the small cell, triangulation of multiple macro RF footprints and so on).

The OAM system determines the density of small cells 101 under each macro cell 102, based on the location of the small cells 101 and the macro cells 102.

The OAM system determines the maximum interference contributed by the small cell 101 radio access network and acceptable by the macro 102, The OAM system compares the determined maximum interference with an interference threshold. If the OAM system determines that the determined maximum interference is greater than the interference threshold, the cellular network considers that the small cell 101 layer causes more interference than what is acceptable at the macro cell 102 layer. The OAM system may limit the interference caused by the small cell 101 layer to the macro cell 102 layer by capping the transmit power from the small cell 101 and/or the transmit power from the mobile devices connected to that small cell 101.

To assist the small cell in doing so, the OAM system calculates a new interference threshold the small cell 101 layer can contribute to the macro cell 102 layer. The interference threshold depends on the density of small cells 101 under the macro cell 102. In effect, the smaller the number of small cells 101, the lesser the interference caused by the small cell 101 layer to the macro cell 102 layer. In converse, the greater the small cell 101 density under a macro cell 102, the greater the potential for increased interference from the small cell 101 layer to the macro cell 102 layer. To this effect, the OAM system first determines the density of small cells 101 under a given macro cell 102. In one embodiment, with such knowledge, the OAM system determines an upper limit for the downlink transmission power for each small cell 101 and/or the mobile devices using those small cells 101.

Small cell mobiles cause interference to the macro layer 102 on the uplink. Taking the example of WCDMA, contrary to the power control which affects only other small cell mobiles, uplink interference as an issue will affect the macro layer 102. Thus it is often viewed as critical by operators and providing a solution must have high priority. Limiting the small cell mobile's transmit power is a solution to this problem.

With the overlay of small cells 101 into the existing macro cell layer 102, the impact of the small cells on the performance of the network made up of macro cells 102 can be measured by the level of interference they cause at the macro layer. Let the maximum allowable addition to the received power at the macro, due to the small cell mobiles, be denoted as ΔP_{I,max}. That is to say

ΣᵢPᵢ^{UE}Lᵢ^{M}≦ΔP_{I,max} (Equation 1)

Where Pᵢ^{UE} gives the transmit power of the i^{th} user equipment (UE), and Lᵢ^{M} gives the path loss from the i^{th} UE to the macro cell (M) 102.

The goal is to place a limit on each small cell mobile's incremental effect on the Macro cell's Rise over thermal (RoT). From (equation 1), the limit for each mobile is given by

P_{i,max}^{UE}Lᵢ^{M}≦ΔP_{I,max}/N (Equation 2)

Where N is the number of mobiles that are susceptible to cause substantial interference to a specific macro cell 102. The right hand side ΔP_{I,max}/N can be computed at the OAM based on the known location of the small cells and macros, and on the level of interference allowed by the operator. ΔP_{I,max} is a value that is calculated by OAM or by the small cell 101 based on density of small cells. The value is linearly multiplied by the density of small cells 101 under the macro cell 102.

The OAM system communicates the new upper limits to the respective small cells 101. The small cells 101 based on the upper limit, updates and uses the new upper limit for its downlink transmission and signals the upper limit for mobile devices' uplink transmissions via a suitable means. For example, in WCDMA, the small cell 101 may update the System Information Block #3 to indicate the maximum uplink transmission power allowed for the various mobile devices.

In another embodiment, the OAM system computes only the allowed interference threshold from the small cell 101 layer to the macro cell 102 layer. In such an embodiment, the OAM system updates this interference threshold at the small cell 101 and the small cell 101 computes the maximum allowed uplink and downlink transmission powers.

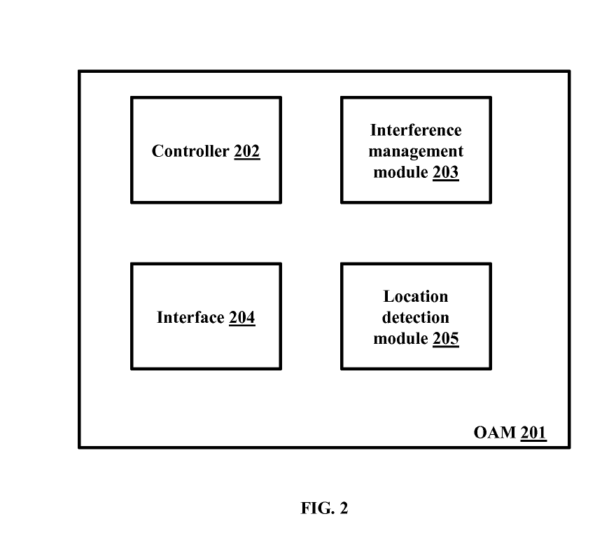

FIG. 2 depicts an OAM system 201, according to an embodiment as disclosed herein. The OAM system 201 is present within the cellular network and comprises a controller 202, an interference management module 203, an interface 204 and a location detection module 205.

The controller 202 receives information from the small cells 101 via the interface 204, connected to the cellular network in a continuous manner. The interface 204 may use a suitable protocol such as TR-069 for communicating information with the cell. The information received by the controller 202 comprises information such as the location of the cells (may be macro cells or small cells), the strongest cell detected by each cell (wherein the strongest cell may be a macro cell 102 or a small cell 101), power at which each cell is transmitting and so on. The cells may indicate the strongest cell using a suitable scanning means, such as REM scan, ANR, and so on. The controller 202 may be configured to request the information at periodic pre-defined intervals. The controller 202 may also allow for the small cell 101 to autonomously provide such information. The controller 202 may configure the cells to send the information on a specific event occurring (such as the small cell starting up and so on). The controller 202 may also configure the cells to send the information at periodic pre-defined intervals.

In another embodiment herein, the location detection module 205 may detect the location of the cells using an available suitable method (such as Global Positioning System (GPS), triangulation and so on). On detecting the location of the cells, the location detection module 205 may inform the current location of the cells to the controller 202. The location may be determined in terms of Cell Identities of macro cells 102, GPS co-ordinates locating the small cell 101, co-ordinates related to a pre-defined fixed point (wherein the fixed point may be a specific geographical location (such as the location of the nearest macro cell, a prominent geographical location and so on)).

The controller 202 receives such information from a plurality of small cells 101 as and when the small cells 101 attach to the network. Due to spectrum management and governmental regulations, registration of small cells may be mandatory. For example, in geographies covering the United States of America and Europe, the small cell 101 currently must be located sufficiently accurately before they are given the rights to turn transmitter on. The controller 202 obtains location information from a plurality of small cells 101 and determines the density of small cells 101 under each macro cell 102, based on the location of the small cells 101 and the macro cells 102. In one embodiment described herein, the controller 202 may keep a counter for each macro cell 102 present in the network and update the counter whenever a small cell 101 reports the macro cell 102 as the strongest. By maintaining such counters and by maintaining the knowledge that a given small cell 101 has reported a given macro cell 102 as the strongest cell, the controller 202 can remain updated with the density of deployment per macro cell 102.

According to certain embodiments, the interference management module 203 determines the maximum interference, which each macro cell 102 is undergoing. The interference management module 203 compares the determined maximum interference with a pre-defined threshold, wherein the pre-defined threshold may be defined by the operator of the cellular network. If the interference management module 203 determines that the determined maximum interference is greater than the pre-defined threshold, the interference management module 203 determines the small cells 101 causing interference to the macro cell 102. The interference management module 203 further determines an upper limit for the downlink transmitting power for each interfering small cell and/or uplink transmission power for the mobiles under that small cell 101. The interference management module 203 communicates the new upper limit to controller 202. The controller 202 further communicates the same to the respective small cells 101, via the interface 204. In another embodiment herein, the interference management module 203 may communicate the upper limit to the respective small cells 101 directly, via the interface 204. In another embodiment, the interference management module 203 communicates the interference threshold to the small cells 101 directly via the interface 204. Noting the interference threshold, each small cell 101 computes the upper limits for downlink and uplink transmission power levels.

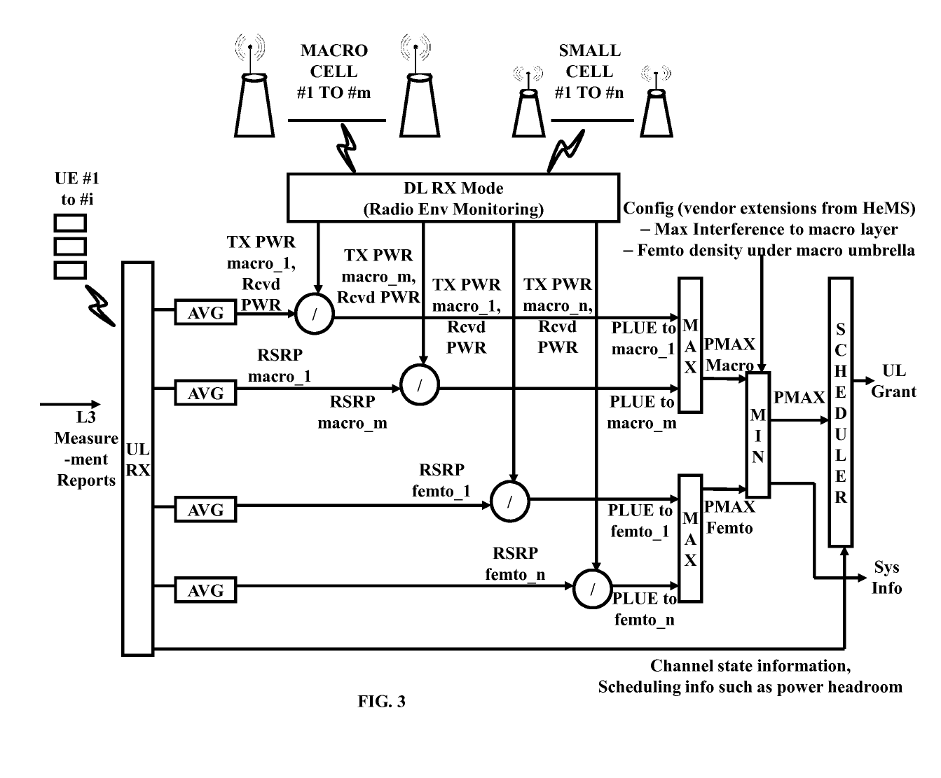

FIG. 3 is a sequence diagram depicting a process of determining a cap for the transmit power for a small base station in the small cell, according to an embodiment as disclosed herein. The small cell 101 has a downlink receive module also referred to as REM. The REM module receives downlink ephemeral data from “m” neighboring macro cells 102 and “n” neighboring small cells 101. While in operation, the small cell 101 also receives measurement reports from one or more of the “i” mobile devices connected.

Based on the actual transmission powers of the neighbors and the actual received powers of those neighbors at the small cell 101, the small cell 101 computes the path losses from those neighboring cells. To account for fluctuations in measurements, the small cell 101 averages measurements from the neighboring cells (measured either via REM or via measurements from the mobile devices) over a number of instances. The small cell 101 also receives pathloss measurements of itself as seen by the mobile devices. Based on these information, the small cell 101 determines the uplink transmission power for the mobile devices as a “minimum function” such that any transmission power from the mobile device reaches only as far as the small cell 101 and not as far as the macro cells 102. This is achieved by signalling the upper limit for the uplink transmission power to the mobile devices.

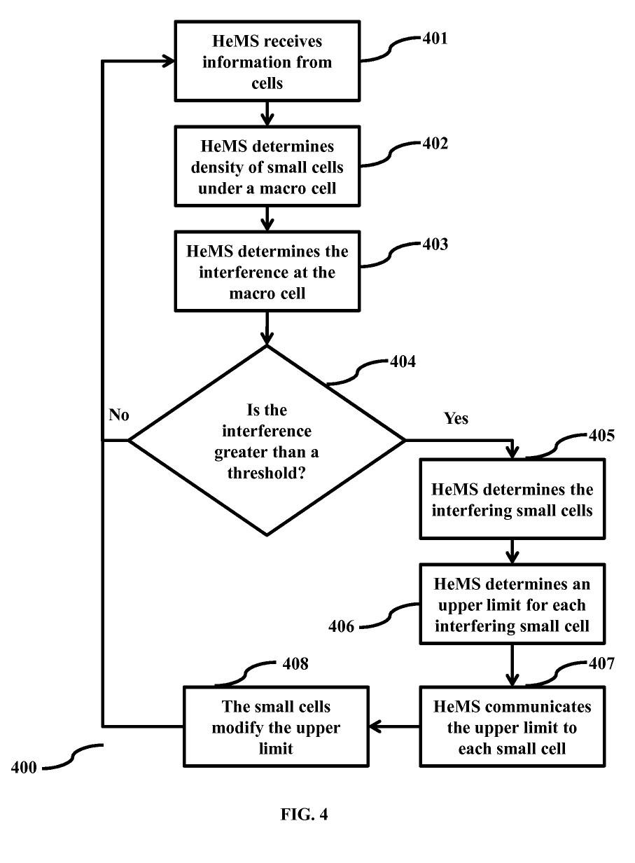

FIG. 4 is a flow chart depicting a process of determining an upper limit for uplink transmission power for a small base station in the small cell, according to an embodiment as disclosed herein.

The cellular network (e.g., HeMS) receives 401 information from the small cells 101 connected to the cellular network in a continuous manner. The information comprises information such as the location of the cells (may be macro cells or small cells), the strongest cell detected by each cell (wherein the strongest cell may be a macro cell 102 or a small cell 101), power at which each cell is transmitting and so on. The cells may indicate the strongest cell using a suitable scanning means, such as REM scan, ANR and so on. A suitable protocol such as TR196 may be used for communicating information between the cellular network and the cell. The information may be received at periodic pre-defined intervals. The information may be also sent by the cells to the cellular network on a specific event occurring (such as the small cell starting up and so on). In another embodiment herein, the cellular network may detect the location of the cells using an available suitable method (such as Global Positioning System (GPS), triangulation and so on). The cellular network determines 402 the density of small cells 101 under each macro cell 102, based on the location of the small cells 101 and the macro cells 102. The cellular network determines 403 the maximum interference, which each macro cell 102 is undergoing. The cellular network compares 404 the determined maximum interference with a pre-defined threshold, wherein the pre-defined threshold may be defined by the operator of the cellular network. If the cellular network determines that the determined maximum interference is greater than the pre-defined threshold, the cellular network determines 405 the small cells 101 causing interference to the macro cell 102. The cellular network further determines 406 an upper limit for the transmitting power for each interfering small cell, based on the current transmitting power of each small cell 101. The cellular network communicates 407 the upper limit to the respective small cells 101. The small cells 101 based on the upper limit, modifies 408 the upper limit of its transmitting power.

The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The one or more hardware device may include one or more processor, according to certain embodiments. The at least one software program may include computer executable instructions stored on a computer readable storage medium (e.g., memory device), according to certain embodiments. The network elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for controlling uplink transmission power of a mobile device under a small cell in a communication network, the method comprising:
receiving information including signal power measurements about at least one macro cell from at least one small cell by an operations and maintenance (OAM) system;
determining the number of neighboring small cells under each of the at least one macro cell by the OAM system based on reported signal power measurements by the small cells;
determining a maximum interference threshold contributed by at least one neighboring small cell for each of the at least one macro cell by the OAM system;
determining interference contributed by the at least one neighboring small cell for each of the at least one macro cell by the OAM system;
determining an upper limit for the maximum uplink transmission power for mobiles serviced by each of the at least one neighboring small cell by the OAM system, if the determined interference is greater than or equal to the maximum interference threshold; and
updating the upper limit of the maximum uplink transmission power for mobiles serviced by each of the at least one neighboring small cell, on the OAM system communicating the determined upper limit for the maximum uplink transmission power to each of the at least one neighboring cell.

2. The method, as claimed in claim 1, wherein the information further comprises a location of the at least one macro cell and at least one small cell, radio frequency (RF) footprints of the at least one macro cell, and cell identities of the at least one macro cell.

3. The method, as claimed in claim 2, wherein the method further comprises obtaining the RF footprints by the OAM system using a network listening function at the small cell.

4. The method, as claimed in claim 1, wherein the method further comprises determining the maximum interference threshold by the OAM system based on the information received about at least one macro cell from at least one small cell.

5. A communication network comprising an operations and maintenance (OAM) system, wherein the OAM system is adapted for controlling uplink transmission power of mobiles serviced by a small cell in the communication network, the OAM system configured for:
receiving information about at least one macro cell from at least one small cell;
determining the number of neighboring small cells under each of the at least one macro cell based on reported signal power measurements by the small cells;
determining a maximum interference threshold contributed by at least one neighboring small cell for each of the at least one macro cell;
determining interference contributed by the at least one neighboring small cell to each of the at least one macro cell; and
determining an upper limit for the maximum uplink transmission power for mobiles serviced by each of the at least one neighboring small cell, if the determined interference is greater than or equal to the maximum interference threshold.

6. The communication network, as claimed in claim 5, wherein the information received by the OAM system comprises a location of the at least one macro cell, radio frequency (RF) footprints of the at least one macro cell, and cell identities of the at least one macro cell.

7. The communication network, as claimed in claim 5, wherein the OAM system is configured for obtaining the RF footprints using a network listening function at the small cell.

8. The communication network, as claimed in claim 5, wherein the OAM system is configured for determining the maximum interference threshold based on the information received about the at least one macro cell from the at least one small cell.

9. The communication network, as in claim 5, wherein the OAM system is further configured for transmitting the determined upper limit to each of the at least one neighboring small cell.

10. An operations and maintenance (OAM) system in a communication network, wherein the OAM system is adapted for controlling uplink transmission power of mobiles serviced by a small cell in the communication network, the OAM system configured for:
receiving information about at least one macro cell from at least one small cell;
determining the number of neighboring small cells under each of the at least one macro cell based on reported signal power measurements by the small cells;
determining a maximum interference threshold contributed by at least one neighboring small cell to each of the at least one macro cell;
determining interference contributed by the at least one neighboring small cell for each of the at least one macro cell; and
determining an upper limit for the maximum uplink transmission power for mobiles serviced by each of the at least one neighboring small cell, if the determined interference is greater than or equal to the maximum interference threshold.

11. The OAM system, as claimed in claim 10, wherein the information received by the OAM system comprises a location of the at least one macro cell, radio frequency (RF) footprints of the at least one macro cell and cell identities of the at least one macro cell.

12. The OAM system, as claimed in claim 11, wherein the OAM system is configured for obtaining the RF footprints using a network listening function at the small cell.

13. The OAM system, as claimed in claim 10, wherein the OAM system is configured for determining the maximum interference threshold based on the information received from the at least one macro cell and the at least one small cell.

14. The OAM system, as claimed in claim 10, wherein the OAM system is further configured for transmitting the determined upper limit to each of the at least one neighboring small cell.
